(19) United States
(12) Patent Application Publication
(10) Pub. No.: US 2023/0194316 A1
(43) Pub. Date: Jun. 22, 2023

(54) POSITION MEASURING DEVICE FOR A ROTARY ELECTRIC MACHINE STATOR UNIT

(71) Applicant: VALEO EQUIPEMENTS ELECTRIQUES MOTEUR, Creteil Cedex (FR)

(72) Inventor: Rachid HAMDI, St Quentin Fallavier (FR)

(73) Assignee: VALEO EQUIPEMENTS ELECTRIQUES MOTEUR, Creteil Cedex (FR)

(21) Appl. No.: 18/067,351

(22) Filed: Dec. 16, 2022

(30) Foreign Application Priority Data
Dec. 17, 2021 (FR) 21 13854

(51) Int. Cl. G01D 18/00; G01D 5/14; G01B 7/30

(52) U.S. Cl. CPC G01D 18/001; G01D 5/145; G01B 7/30

(57) ABSTRACT

A position measuring device intended for a rotary electric machine. The position measuring device includes a position sensor and a fixing arm projecting with respect to the sensor compartment, wherein the fixing arm has an orifice exhibiting a central axis. The fixing arm has at least one slot made in the periphery of the orifice, the slot exhibiting a depth, in the direction of the central axis as far as a bottom wall, greater than or equal to 2 mm, the slot being configured to receive a tooth of a calibration tool. The invention also relates to the calibration tool cooperating with the position measuring device.

### TECHNICAL FIELD

The present invention relates to a position measuring device for a rotary electric machine stator unit, to a stator unit comprising such a position measuring device and to a rotary electric machine comprising this stator unit. The present invention also relates to a calibration tool for such a position measuring device and to a method for calibrating such a position measuring device with a calibration tool.

The invention lies in particular in the field of rotary electric machines such as electric motors, alternators, or starter-alternators for motor vehicles.

### TECHNOLOGICAL BACKGROUND

The document FR3108974 discloses position measuring devices for a stator unit of a rotary electric machine.

Rotary electric machines comprise a stator unit having a stator provided with at least one copper winding. Rotary electric machines also comprise a rotor mounted so as to rotate in the stator unit and with respect to the latter. The stator unit comprises a casing surrounding and protecting the stator.

The electric machine comprises a position measuring device having a sensor compartment intended to house at least one position sensor that measures the position of the rotor with respect to the stator. The use of a plurality of position sensors also makes it possible to measure the position and the speed of the rotor.

The position measuring device is positioned radially inside the winding, and facing a rotating target fixed to the rotor, so as to allow the position sensor to detect the target. For example, the position sensor may be a Hall effect sensor that detects magnets forming part of the target, or an optical sensor.

The position measuring device comprises a fixing arm projecting perpendicularly with respect to the sensor compartment toward the axis of rotation of the rotor.

The casing of the stator unit comprises a bearing or flange positioned at one axial end of the rotary electric machine. The fixing arm comprises a main portion and an end portion fixed to this bearing.

The main portion comprises an orifice which exhibits a central axis aligned with the axis of rotation of the rotor and through which the shaft of the rotor passes.

The position measuring device is arranged so that it can be rotated, using a calibration tool, with respect to the bearing and to the rotor target about the axis of rotation of the rotor before it is finally fixed to the bearing.

This makes it possible to manually synchronize or calibrate the rotor target signal with the position sensors. The position measuring device has slots that each cooperate with a tooth of the calibration tool such that the rotation of the calibration tool causes the position measuring device to rotate so as to correct the angular position of the position sensor with respect to the rotor target.

However, the design of the position measuring devices in the document FR3108974 leads to drawbacks, in particular undesired uncoupling of the calibration tool from the position measuring device during calibration and a loss of precision of the calibration caused by play between the calibration tool and the position measuring device.

### SUMMARY

One idea underlying the invention is to improve the coupling between the position measuring device and the calibration tool in order to improve the precision of the angular positioning of the position measuring device with respect to the stator unit.

According to one embodiment, the invention provides a position measuring device intended for a rotary electric machine having a stator unit and a rotor mounted so as rotate in and with respect to the stator unit about an axis of rotation, the position measuring device comprising a position sensor that is intended to measure the position of the rotor with respect to the stator unit and is housed in a sensor compartment, the position measuring device being intended to be positioned in an axial end zone of the stator unit so as to allow the position sensor to detect a rotating target connected to the rotor, the position measuring device comprising a fixing arm projecting towards the axis of rotation with respect to the sensor compartment, wherein the fixing arm has an orifice that is intended to receive a shaft of the rotor and exhibits a central axis intended to be aligned with the axis of rotation of the rotor, and wherein the fixing arm has at least one slot provided in the periphery of the orifice, the slot exhibiting a depth, in the direction of the central axis and as far as a bottom wall, that is greater than or equal to 2 mm, the slot being configured to receive a tooth of a calibration tool.

By virtue of these features, the depth of the slot of the position measuring device makes it possible to improve the coupling between the position measuring device and the calibration tool, this having the advantage of greatly limiting accidental uncoupling during calibration. Specifically, the inventors have found that a slot having a depth less than or equal to 1.5 mm did not make it possible to have sufficiently reliable coupling.

According to embodiments, such a position measuring device may have one or more of the following features.

According to one embodiment, the slot exhibits a depth of between 2 and 5 mm, for example equal to 4 mm.

According to one embodiment, the slot has two lateral walls and a radially external wall, the lateral walls being disposed circumferentially on either side of the radially external wall.

According to one embodiment, the lateral walls comprise a first lateral wall and a second lateral wall, the first lateral wall being formed in a plane inclined at a first non-zero angle with respect to a radial plane passing through the central axis of the orifice, the second lateral wall being formed in a plane inclined at a second non-zero angle with respect to a radial plane passing through the central axis of the orifice, the first angle and the second angle being opposite to one another, the inclination of the lateral walls being configured such that the slot has a circumferential dimension that narrows in the direction of the bottom wall.

Thus, the inclination of the lateral walls of the slot makes it possible to ensure contact between the slot and the tooth on either side of the slot, without having to worry about any play, as is the case when the lateral walls are not inclined. This thus makes it possible to increase the precision of calibration.

According to one embodiment, the first angle and the second angle lie in terms of absolute value between 5 and 35°, preferably between 5 and 15°, and for example are equal to 10°.

According to one embodiment, the radially external wall exhibits the shape of an angular sector of a cone frustum exhibiting symmetry of revolution about the central axis and having a non-zero vertex half-angle, the inclination of the radially external wall being configured such that the slot has a radial dimension that narrows in the direction of the bottom wall.

Thus, the inclination of the radially external wall, due to the frustoconical shape, of the slot makes it possible to ensure contact between the slot and the tooth, without having to worry about any play, as is the case when the radially external wall is not inclined. This thus makes it possible to increase the precision of calibration.

According to one embodiment, the vertex half-angle lies between 5 and 35°, preferably between 5 and 15°, and for example is equal to 10°.

According to one embodiment, the fixing arm has a plurality of slots, for example two, three or four.

According to one embodiment, the slots are distributed regularly all around the periphery of the orifice, there being for example three slots.

According to one embodiment, the fixing arm has a main portion in which the orifice is made, and a peripheral portion that is situated around the main portion and is fixed to the main portion.

According to one embodiment, the sensor compartment and the main portion of the fixing arm are made from a polymer material.

According to one embodiment, the peripheral portion is made of metal.

According to one embodiment, the peripheral portion comprises a plurality of fixing holes, fixing means being intended to pass through the fixing holes in the fixing arm so as to fix the fixing arm to a bearing of the stator unit.

According to one embodiment, the peripheral portion is overmoulded in the main portion of the fixing arm during an overmoulding operation so as to obtain a peripheral portion integrated into the main portion.

This makes it possible to simplify the process of manufacturing the position measuring device. Only one moulding step is necessary. There are fewer parts to assemble and manage.

According to one embodiment, each fixing hole exhibits an elongate and curved shape, the curvature of the fixing holes having the central axis as its centre of curvature.

According to one embodiment, the fixing holes are distributed regularly all around the orifice, there being for example three fixing holes.

According to one embodiment, each slot opens out radially into the orifice.

According to one embodiment, the invention also provides a calibration tool intended to calibrate a position measuring device for a rotary electric machine stator unit comprising a stator in which a winding is disposed, the rotary electric machine comprising a rotor mounted so as to rotate in and with respect to the stator unit about an axis of rotation, wherein the calibration tool has a cylindrical body exhibiting symmetry of revolution about a central axis and exhibiting at least one tooth at one end, the tooth exhibiting a length in the direction of the central axis of greater than or equal to 2 mm, the tooth being configured to fit in a slot of a position measuring device.

By virtue of these features, and analogously to the depth of the slot, the length of the tooth of the calibration tool makes it possible to improve the coupling between the position measuring device and the calibration tool, this having the advantage of greatly limiting accidental uncoupling during calibration.

According to one embodiment, the tooth exhibits a length of between 2 and 5 mm, for example equal to 4 mm.

According to one embodiment, the tooth has an axial end surface intended to face a bottom wall of a slot of the position measuring device, a radially external surface situated in the continuation of the cylindrical body, and two lateral surfaces situated on either side of the radially external surface.

According to one embodiment, the lateral surfaces comprise a first lateral surface and a second lateral surface, the first lateral surface being formed in a plane inclined at a first non-zero angle with respect to a radial plane passing through the central axis of the cylindrical body, the second lateral surface being formed in a plane inclined at a second non-zero angle with respect to a radial plane passing through the central axis of the orifice, the first angle and the second angle being opposite to one another, the inclination of the lateral surfaces being configured such that the tooth has a circumferential dimension that narrows in the direction of the axial end surface.

According to one embodiment, the first angle and the second angle lie in terms of absolute value between 5 and 35°, preferably between 5 and 15°, and for example are equal to 10°.

According to one embodiment, the radially external surface exhibits the shape of an angular sector of a cone frustum exhibiting symmetry of revolution about the central axis and having a non-zero vertex half-angle, the inclination of the radially external surface being configured such that the tooth has a radial dimension that narrows in the direction of the axial end surface.

According to one embodiment, the vertex half-angle lies between 5 and 35°, preferably between 5 and 15°, and for example is equal to 10°.

According to one embodiment, the tooth is made at a periphery of the end of the cylindrical body.

According to one embodiment, the fixing arm has a plurality of teeth, for example two, three or four.

According to one embodiment, the teeth are distributed regularly all around a periphery of the end of the cylindrical body.

According to one embodiment, the invention also provides an assembly comprising an abovementioned position measuring device and an abovementioned calibration tool.

According to one embodiment, the invention also provides a rotary electric machine stator unit comprising a stator, wherein the stator unit comprises an abovementioned position measuring device, the position measuring device being positioned in an axial end zone of the stator unit so as to allow the position sensor to detect a rotating target connected to the rotor.

According to one embodiment, the invention also provides a rotary electric machine comprising an abovementioned stator unit, and a rotor mounted so as to rotate in and with respect to the stator unit about the axis of rotation.

According to one embodiment, the invention also provides a method for calibrating a position measuring device in a rotary electric machine, wherein the method comprises the following steps:

providing a rotary electric machine comprising a stator unit, and a rotor mounted so as to rotate in and with respect to the stator unit about an axis of rotation, the stator unit comprising a stator provided with a winding, and an abovementioned position measuring device,

providing an abovementioned calibration tool,

positioning the position measuring device in an axial end zone of the stator unit,

coupling the calibration tool to the position measuring device by positioning the at least one tooth in the at least one slot,

calibrating the position measuring device with the target connected to the rotor with the aid of the calibration tool,

fixing the position measuring device to the stator unit and uncoupling the calibration tool from the position measuring device.

### BRIEF DESCRIPTION OF THE FIGURES

The invention will be understood better, and further aims, details, features and advantages thereof will become more clearly apparent, from the following description of a plurality of particular embodiments of the invention, which are given only by way of non-limiting illustration, with reference to the appended drawings.

FIG. 1 shows a partial perspective view of a rotary electric machine comprising a stator unit and a position measuring device according to one embodiment.

FIG. 2 is a perspective view of a position measuring device and of a calibration tool before coupling, according to one embodiment.

FIG. 3 is a view in section on the plane Ill in FIG. 2 when the calibration tool is coupled to the position measuring device, according to a first embodiment.

FIG. 4 is a view in section on the plane III in FIG. 2 when the calibration tool is coupled to the position measuring device, according to a second embodiment.

FIG. 5 is a view in section on the plane III in FIG. 2 when the calibration tool is coupled to the position measuring device, according to a third embodiment.

FIG. 6 is a view in section on the plane III in FIG. 2 when the calibration tool is coupled to the position measuring device, according to a fourth embodiment.

### DESCRIPTION OF THE EMBODIMENTS

In the description and the claims, the “axial” and “radial” orientations will be used to designate, according to the definitions given in the description, elements of the position measuring device and of the calibration tool. By convention, the central axis of the orifice in the fixing arm rotation or in the calibration tool defines the “axial” orientation. The “radial” orientation is directed orthogonally to the axis X and from inside to outside away from said axis, and the “circumferential” orientation is directed orthogonally to the central axis and orthogonally to the radial direction. The term “external” is used to define the relative position of one element with respect to another, with reference to the central axis; an element away from the central axis is thus referred to as external as opposed to an internal element that is situated radially closest to the central axis.

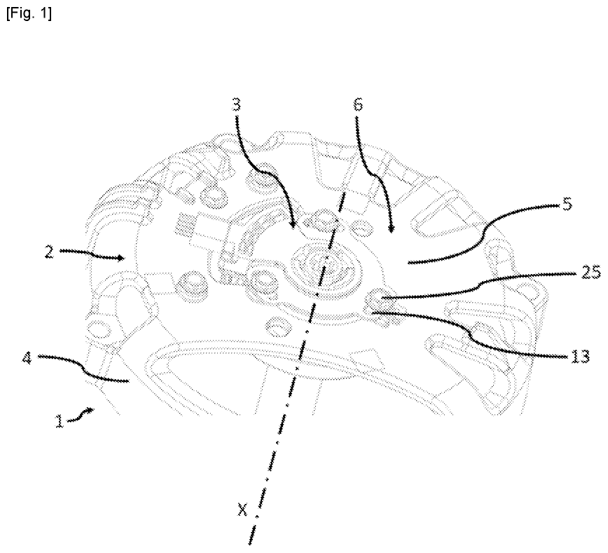

FIG. 1 shows a rotary electric machine 1 comprising a stator unit 2 having a position measuring device 3 according to one embodiment.

The rotary electric machine 1 may be for example an electric motor for an electric or hybrid motor vehicle. The invention also applies to other types of rotary electric machine such as an alternator or starter-alternator of a motor vehicle.

The stator unit 2 comprises a stator, in which a winding is disposed. A winding is understood to be one or more coils, based for example on copper. The rotary electric machine 1 also comprises a rotor mounted so as to rotate with respect to the stator unit 2 about an axis of rotation X inside the winding.

The stator unit 2 comprises a casing 4 surrounding the stator and the rotor in order to protect them. The casing 4 comprises at least one flange which is positioned at one axial end 6 of the rotary electric machine 1 and which forms a bearing 5 that guides the rotation of the shaft of the rotor. The bearing 5 extends generally in a plane perpendicular to the axis of rotation X.

The position measuring device 3 is arranged so that it can be rotated with respect to the bearing 5 and to the rotor target about the axis of rotation X of the rotor before it is finally fixed to the bearing 5.

This makes it possible to calibrate the rotor target signal with the position sensors. This calibration step is carried out using a calibration tool 7 that cooperates with the position measuring device 3 such that the rotation of the calibration tool 7 causes the position measuring device 3 to rotate so as to correct the angular position of the position sensor with respect to the rotor target. Specifically, during calibration, the electrical phase shift between the signals from the position sensor and the voltages of the motor is measured. The position sensor is thus rotated until the desired phase shift is obtained. For the calibration, the electric motor is driven in rotation.

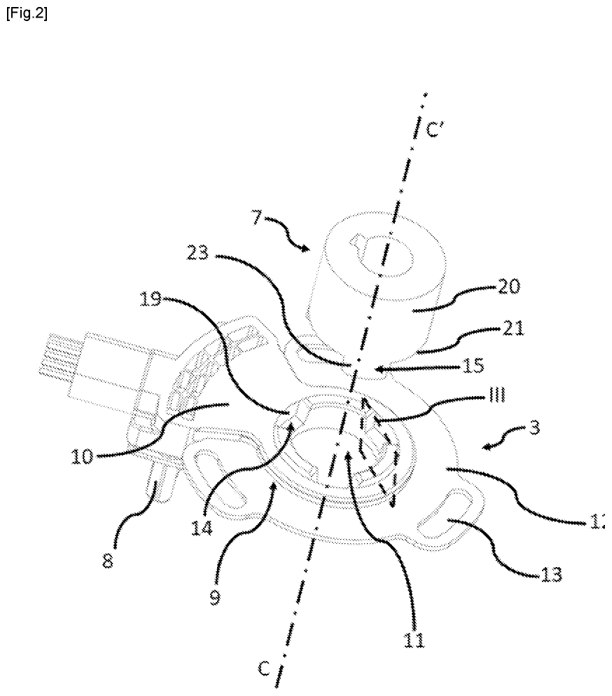

The position measuring device 3 and the calibration tool 7 will be described more particularly below with reference in particular to FIGS. 2 to 6.

FIG. 2 shows in particular the position measuring device 3 and the calibration tool 7 before they are coupled, according to one embodiment.

The position measuring device 3 comprises a sensor compartment 8 housing at least one position sensor that measures the position of the rotor with respect to the stator unit 2. The position measuring device 3 may comprise a plurality of position sensors for measuring the position and the speed of the rotor. The position sensors may be Hall effect sensors that detect the position and measure the speed of the rotor by means of magnets forming part of the target fixed to the rotor, for example. Other types of position sensor may be used, such as optical sensors or inductive sensors.

The position measuring device 3 is positioned at the axial end 6 of the stator unit 2 so as to allow the position sensor to detect a rotating target connected to the rotor. The position measuring device 3 is thus situated between the rotor and the bearing 5 and radially inside the stator unit 2.

The position measuring device 3 comprises a fixing arm 9 projecting perpendicularly from the sensor compartment 8 towards the axis of rotation X, as shown in FIGS. 1 and 2.

The fixing arm 9 also has a main portion 10 comprising an orifice 11 exhibiting a central axis C intended to be aligned with the axis of rotation X of the rotor when the position measuring device 3 is mounted on the bearing 5. The orifice 11 is intended to receive the shaft of the rotor.

The fixing arm 9 also has a peripheral portion 12 that is situated around the main portion 10 and is fixed to the main portion 10. The sensor compartment 8 and the main portion 10 of the fixing arm 9 are made for example from a polymer material, while the peripheral portion 12 is made of metal.

The peripheral portion 12 may for example be overmoulded in the main portion 10 during an overmoulding operation so as to obtain a peripheral portion 12 integrated into the main portion 10.

As can be seen in FIG. 2, the peripheral portion 12 comprises, in this embodiment, three fixing holes 13 that are distributed regularly all around the orifice 11. Fixing means, such as screws 25, pass through the fixing holes 13 so as to fix the fixing arm 9 to the bearing 5 of the stator unit 2. Each fixing hole 13 has an elongate and curved shape, the curvature of which has the central axis C as its centre. The shape of the fixing holes 13 allows the rotation of the position measuring device 3 during the calibration of the position sensors with the rotor target.

As set out above, the calibration step is carried out using a calibration tool 7 that cooperates with the position measuring device 3, the calibration step being carried out after the position measuring device 3 has been positioned on the stator unit 2 and before it is finally fixed.

This cooperation is achieved with the aid of slots 14 made in the position measuring device 3 and teeth 15 made on the calibration tool 7.

Specifically, as shown in FIG. 2, the main portion 10 of the fixing arm 9 has three slots 14 that are made in the periphery of the orifice 11 and are distributed regularly around the latter. Each slot 14 is advantageously spaced apart from the adjacent slots 14 by a protuberance 16 projecting axially from the main portion 10. In the example shown, the slots 14 exhibit a depth, in the direction of the central axis C as far as a bottom wall 17, equal to around 4 mm.

Each slot 14 thus has two lateral walls 18 and a radially external wall 19. The lateral walls 18 are disposed circumferentially on either side of the radially external wall 19.

The calibration tool 7 has a cylindrical body 20 exhibiting symmetry of revolution about a central axis C′ and having, at one end 21, three teeth 15 that are distributed regularly all around the periphery of the end 21. In other embodiments that are not shown, the number of teeth 15 and the number of slots 14 may vary as required, as long as the positioning of the teeth 15 matches the positioning of the slots 14.

In the same way as for the slots 14, in the example shown, each tooth 15 has a length in the direction of the central axis C′ equal to around 4 mm. Each tooth 15 is thus configured to fit in one of the slots 14 of the position measuring device 3.

Each tooth 15 has an axial end surface 22 situated facing the bottom wall 17 of a slot 14 when the calibration tool 7 is coupled to the position measuring device 3. Each tooth 15 also has a radially external surface 23 situated in the continuation of the cylindrical body 20, and two lateral surfaces 24 situated on either side of the radially external surface 23.

During coupling, each lateral surface 24 of a tooth 15 is situated facing a lateral wall 18 of a slot 14. In the same way, the radially external surface 23 of the tooth 15 is situated facing the radially external wall 19 of the slot 14. During coupling, the central axis C of the orifice 11 coincides with the central axis C′ of the cylindrical body 20.

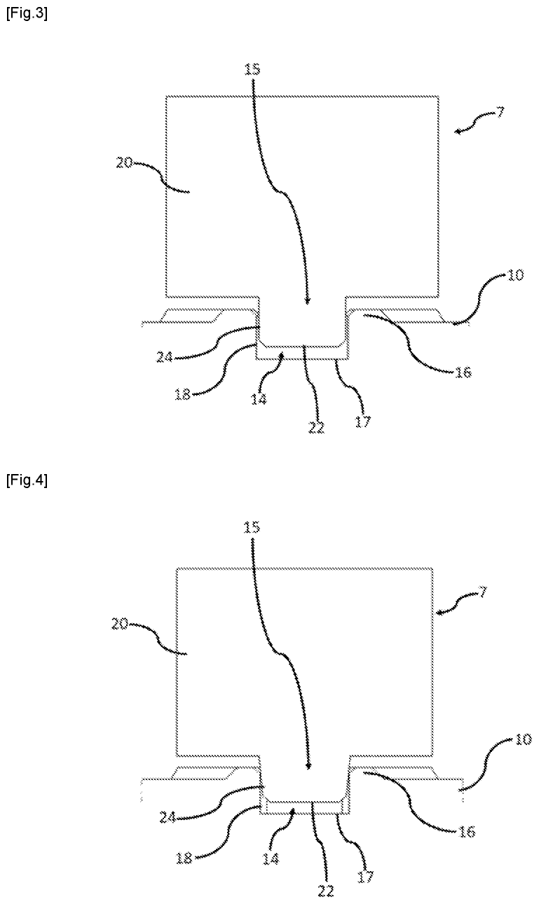

FIGS. 3 to 6 show different embodiments of the position measuring device 3 and of the calibration tool 7, revealing the coupling between a tooth 15 and a slot 14.

In the embodiment in FIG. 3, the lateral walls 18 of the slot 14 and the lateral surfaces 24 of the tooth 15 are formed in radial planes that pass through the central axis C of the orifice 11 or through the central axis C′ of the cylindrical body 20, respectively, such that each lateral wall 18 is parallel to a lateral surface 24. The lateral walls 18 are thus perpendicular to the bottom wall 17 while the lateral surfaces 24 are perpendicular to the axial end surface 22.

The embodiment in FIG. 4 differs from the embodiment in FIG. 3 in that the lateral surfaces 24 of the tooth 15 are inclined at an angle, of 10° in the example shown, with respect to a radial plane passing through the central axis C′ of the cylindrical body 20. The inclination of one lateral surface 24 is opposite to the inclination of the other lateral surface 24. Moreover, the inclination of the lateral surfaces 24 is realized such that the tooth 15 has a circumferential dimension that narrows in the direction of the axial end surface 22. Thus, the lateral surfaces 24 exhibit an angle of 100° with the axial end surface 22.

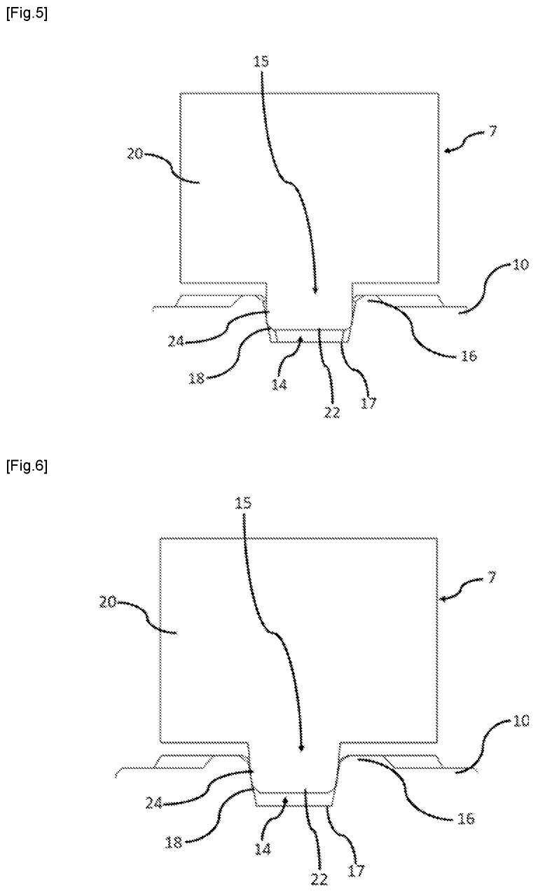

The embodiment in FIG. 5 differs from the embodiment in FIG. 3 in that the lateral walls 18 of the slot 14 are inclined at an angle, of 10° in the example shown, with respect to a radial plane passing through the central axis C of the orifice 11. The inclination of one lateral wall 18 is opposite to the inclination of the other lateral wall 18. Moreover, the inclination of the lateral walls 18 is realized such that the slot 14 has a circumferential dimension that narrows in the direction of the bottom wall 17. Thus, the lateral walls 18 exhibit an angle of 100° with the bottom wall 17.

The embodiment in FIG. 6 corresponds to a combination of the features of the embodiment in FIG. 4 and those of the embodiment in FIG. 5. Specifically, in this embodiment, the lateral walls 18 of the slot 14 and the lateral surfaces 24 of the tooth 15 are inclined at an angle of 10° in the example shown. Thus, each lateral surface 24 is parallel to a lateral wall 18.

The inclination of the lateral walls 18 and/or the inclination of the lateral surfaces 24 makes it possible to ensure contact between the slot 14 and the tooth 15 on either side of the slot 14, without having to worry about any play. This thus makes it possible to increase the precision of calibration.

Moreover, advantageously, the radially external wall 19 exhibits the shape of an angular sector of a cone frustum exhibiting symmetry of revolution about the central axis C and having a non-zero vertex half-angle, for example of 10°. The inclination of the radially external wall 19 is realized such that the slot 14 has a radial dimension that narrows in the direction of the bottom wall 17.

In the same way, advantageously, the radially external surface 23 exhibits the shape of an angular sector of a cone frustum exhibiting symmetry of revolution about the central axis C′ and having a non-zero vertex half-angle, for example of 10°. The inclination of the radially external surface 23 is realized such that the tooth 15 has a radial dimension that narrows in the direction of the axial end surface 22.

The inclination of the radially external wall 19 and/or of the radially external surface 23, due to the frustoconical shape, of the slot 14 and/or of the tooth 15 makes it possible to ensure contact between the slot 14 and the tooth 15, without having to worry about any play. This thus makes it possible to increase the precision of calibration.

Although the invention has been described in connection with multiple particular embodiments, it is quite obvious that it is in no way limited thereto and that it comprises all the technical equivalents of the means described and combinations thereof where these fall within the scope of the invention.

The use of the verb “have”, “comprise” or “include” and conjugated forms thereof does not exclude the presence of elements or steps other than those stated in a claim.

In the claims, any reference sign between parentheses should not be interpreted as limiting the claim.

1. Position measuring device intended for a rotary electric machine having a stator unit and a rotor mounted so as rotate in and with respect to the stator unit about an axis of rotation, the position measuring device comprising a position sensor that is intended to measure the position of the rotor with respect to the stator unit and is housed in a sensor compartment, the position measuring device being intended to be positioned in an axial end zone of the stator unit so as to allow the position sensor to detect a rotating target connected to the rotor, the position measuring device comprising a fixing arm projecting towards the axis of rotation with respect to the sensor compartment,
wherein the fixing arm has an orifice that is intended to receive a shaft of the rotor and exhibits a central axis intended to be aligned with the axis of rotation of the rotor, and wherein the fixing arm has at least one slot provided in the periphery of the orifice, the slot exhibiting a depth, in the direction of the central axis and as far as a bottom wall, that is greater than or equal to 2 mm, the slot being configured to receive a tooth of a calibration tool.

2. Position measuring device according to claim 1, wherein the slot has two lateral walls and a radially external wall, the lateral walls being disposed circumferentially on either side of the radially external wall.

3. Position measuring device according to claim 1, wherein the lateral walls comprise a first lateral wall and a second lateral wall, the first lateral wall being formed in a plane inclined at a first non-zero angle with respect to a radial plane passing through the central axis of the orifice, the second lateral wall being formed in a plane inclined at a second non-zero angle with respect to a radial plane passing through the central axis of the orifice, the first angle and the second angle being opposite to one another, the inclination of the lateral walls being configured such that the slot has a circumferential dimension that narrows in the direction of the bottom wall.

4. Position measuring device according to claim 3, wherein the first angle and the second angle lie in terms of absolute value between 5 and 35°.

5. Position measuring device according to claim 2, wherein the radially external wall exhibits the shape of an angular sector of a cone frustum exhibiting symmetry of revolution about the central axis and having a non-zero vertex half-angle, the inclination of the radially external wall being configured such that the slot has a radial dimension that narrows in the direction of the bottom wall.

6. Position measuring device according to claim 1, wherein the fixing arm has a main portion in which the orifice is made, and a peripheral portion that is situated around the main portion and is fixed to the main portion.

7. Calibration tool intended to calibrate a position measuring device for a rotary electric machine stator unit comprising a stator in which a winding is disposed, the rotary electric machine comprising a rotor mounted so as to rotate in and with respect to the stator unit about an axis of rotation, wherein the calibration tool has a cylindrical body exhibiting symmetry of revolution about a central axis (C′) and exhibiting at least one tooth at one end, the tooth exhibiting a length in the direction of the central axis of greater than or equal to 2 mm, the tooth being configured to fit in a slot of a position measuring device.

8. Calibration tool according to claim 7, wherein the tooth has an axial end surface intended to face a bottom wall of a slot of the position measuring device, a radially external surface situated in the continuation of the cylindrical body, and two lateral surfaces situated on either side of the radially external surface.

9. Calibration tool according to claim 8, wherein the lateral surfaces comprise a first lateral surface and a second lateral surface, the first lateral surface being formed in a plane inclined at a first non-zero angle with respect to a radial plane passing through the central axis of the cylindrical body, the second lateral surface being formed in a plane inclined at a second non-zero angle with respect to a radial plane passing through the central axis of the orifice, the first angle and the second angle being opposite to one another, the inclination of the lateral surfaces being configured such that the tooth has a circumferential dimension that narrows in the direction of the axial end surface.

10. Calibration tool according to claim 9, wherein the first angle and the second angle lie in terms of absolute value between 5 and 35°.

11. Calibration tool according to claim 8, wherein the radially external surface exhibits the shape of an angular sector of a cone frustum exhibiting symmetry of revolution about the central axis and having a non-zero vertex half-angle, the inclination of the radially external surface being configured such that the tooth has a radial dimension that narrows in the direction of the axial end surface.

12. Calibration tool according to claim 7, wherein the tooth is made at a periphery of the end of the cylindrical body.

13. Assembly comprising a position measuring device according to claim 1 and a calibration tool intended to calibrate a position measuring device for a rotary electric machine stator unit comprising a stator in which a winding is disposed, the rotary electric machine comprising a rotor mounted so as to rotate in and with respect to the stator unit about an axis of rotation, wherein the calibration tool has a cylindrical body exhibiting symmetry of revolution about a central axis (C′) and exhibiting at least one tooth at one end, the tooth exhibiting a length in the direction of the central axis of greater than or equal to 2 mm, the tooth being configured to fit in a slot of a position measuring device.

14. Method for calibrating a position measuring device in a rotary electric machine, wherein the method comprises the following steps:
providing a rotary electric machine comprising a stator unit, and a rotor mounted so as to rotate in and with respect to the stator unit about an axis of rotation, the stator unit comprising a stator provided with a winding, and a position measuring device according to claim 1,
providing a calibration tool intended to calibrate a position measuring device for a rotary electric machine stator unit comprising a stator in which a winding is disposed, the rotary electric machine comprising a rotor mounted so as to rotate in and with respect to the stator unit about an axis of rotation, wherein the calibration tool has a cylindrical body exhibiting symmetry of revolution about a central axis (C′) and exhibiting at least one tooth at one end, the tooth exhibiting a length in the direction of the central axis of greater than or equal to 2 mm, the tooth being configured to fit in a slot of a position measuring device,
positioning the position measuring device in an axial end zone of the stator unit,
coupling the calibration tool to the position measuring device by positioning the at least one tooth in the at least one slot,
calibrating the position measuring device with the target connected to the rotor with the aid of the calibration tool,
fixing the position measuring device to the stator unit and uncoupling the calibration tool from the position measuring device.

15. Position measuring device according to claim 2, wherein the lateral walls comprise a first lateral wall and a second lateral wall, the first lateral wall being formed in a plane inclined at a first non-zero angle with respect to a radial plane passing through the central axis of the orifice, the second lateral wall being formed in a plane inclined at a second non-zero angle with respect to a radial plane passing through the central axis of the orifice, the first angle and the second angle being opposite to one another, the inclination of the lateral walls being configured such that the slot has a circumferential dimension that narrows in the direction of the bottom wall.

16. Position measuring device according to claim 3, wherein the radially external wall exhibits the shape of an angular sector of a cone frustum exhibiting symmetry of revolution about the central axis and having a non-zero vertex half-angle, the inclination of the radially external wall being configured such that the slot has a radial dimension that narrows in the direction of the bottom wall.

17. Position measuring device according to claim 2, wherein the fixing arm has a main portion in which the orifice is made, and a peripheral portion that is situated around the main portion and is fixed to the main portion.

18. Calibration tool according to claim 9, wherein the radially external surface exhibits the shape of an angular sector of a cone frustum exhibiting symmetry of revolution about the central axis and having a non-zero vertex half-angle, the inclination of the radially external surface being configured such that the tooth has a radial dimension that narrows in the direction of the axial end surface.

19. Calibration tool according to claim 8, wherein the tooth is made at a periphery of the end of the cylindrical body.

20. Assembly comprising a position measuring device according to claim 2 and a calibration tool intended to calibrate a position measuring device for a rotary electric machine stator unit comprising a stator in which a winding is disposed, the rotary electric machine comprising a rotor mounted so as to rotate in and with respect to the stator unit about an axis of rotation, wherein the calibration tool has a cylindrical body exhibiting symmetry of revolution about a central axis (C′) and exhibiting at least one tooth at one end, the tooth exhibiting a length in the direction of the central axis of greater than or equal to 2 mm, the tooth being configured to fit in a slot of a position measuring device.
